(19) United States
(12) Patent Application Publication
(10) Pub. No.: US 2015/0242916 A1
(43) Pub. Date: Aug. 27, 2015

(54) SYSTEMS AND METHODS FOR EXCHANGING TICKETS

(71) Applicant: Sandy Lynn Godsey, San Jose, CA (US)

(72) Inventor: Sandy Lynn Godsey, San Jose, CA (US)

(21) Appl. No.: 14/186,467

(22) Filed: Feb. 21, 2014

(51) Int. Cl. G06Q 30/06; G06Q 30/08; G06Q 10/02

(52) U.S. Cl. CPC G06Q 30/0613; G06Q 10/02; G06Q 30/08

(57) ABSTRACT

A system such as a ticket seller system may provide ticketholders with the ability to swap their tickets for other tickets and/or other goods or services. The system may identify a ticket of a user, identify one or more other tickets, goods or services that may be of interest to the user, and provide a swap offer to the user to exchange the purchased ticket for the other ticket, goods or services. A user may utilize the system to exchange a relatively high value ticket for a relatively lower value ticket and a profit, to exchange a relatively low value ticket for a relatively higher value ticket at an additional cost, or to exchange the ticket for a ticket to another event or a ticket closer to friends. The system may also facilitate the purchase or swapping of tickets in a time-share season ticket package.

### BACKGROUND

1. Technical Field

The present disclosure relates generally to electronic commerce, and more particularly, to the exchanging of purchased event tickets.

2. Related Art

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics.

One example of a market for goods within the realm of electronic commerce is the online ticket market. Various online ticket sellers provide websites through which parties buy and sell tickets online. These tickets are commonly obtained by a user to reserve seats and/or admission for a variety of live events, such as sporting events, concerts, theater events, and other entertainment events. Typically, a buyer looks for available tickets on a ticket marketplace website or other online listing and decides which, if any, of the available tickets are of interest to the buyer for possible purchase.

In some circumstances, a purchased ticket increases in value after purchase. For example, a front row ticket for an event may be purchased at a purchase price and, as the event time approaches, others who were unable to purchase front row tickets become willing to pay a premium for the chance to have the front row ticket. The ticketholder can sell the ticket for a profit, but then risks being unable to attend the event. The ticketholder can preemptively purchase another ticket before selling the high-value ticket. However, it may be undesirable or impossible to spend the money on the additional ticket before receiving the money for the high value ticket.

It may therefore be desirable to provide systems and methods for exchanging tickets for various ticketed events.

### BRIEF DESCRIPTION OF THE DRAWINGS

FIG. 1 is a block diagram of an illustrative computing system that is adapted for implementing the selection, purchase, and exchange of tickets for ticketed events according to an embodiment.

FIG. 2 is a block diagram of an illustrative computer system suitable for implementing on one or more devices of the computing system in FIG. 1 according to an embodiment.

FIG. 3 is a block diagram of an illustrative system for facilitating exchanging of tickets for ticketed events according to an embodiment.

FIG. 4 is a diagram of an illustrative event venue showing various ticket locations and groupings according to an embodiment.

FIG. 5 is diagram of an illustrative user device showing how a swap alert may be provided to a user on the user device prior to an event according to an embodiment.

FIG. 6 is diagram of an illustrative user device showing how a swap alert may be provided to a user on the user device during an event according to an embodiment.

FIG. 7 is diagram of an illustrative user device showing how a swap alert may be provided to a user based on user information according to an embodiment.

FIG. 8 is a flowchart showing an illustrative process that may be performed for exchanging tickets according to an embodiment.

FIG. 9 is a flowchart showing an illustrative process that may be performed for exchanging goods and/or services according to an embodiment.

FIG. 10 is a flowchart showing an illustrative process that may be performed for facilitating a desired ticket exchange according to an embodiment.

FIG. 11 is a flowchart showing an illustrative process that may be performed for triggering a swap offer based on a monitored ticket context according to an embodiment.

FIG. 12 is a flowchart showing an illustrative process that may be performed for facilitating ticket exchanges for co-owners of a time-share season ticket package according to an embodiment.

FIG. 13 is a flowchart showing an illustrative process that may be performed for facilitating group purchase of a season ticket package according to an embodiment.

FIG. 14 is a flowchart showing an illustrative process that may be performed for facilitating group payment for a group purchased season ticket package according to an embodiment.

### DETAILED DESCRIPTION

Various applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

Devices, systems and methods are provided for performing activities related to the online sale, purchase, resale, and swapping of tickets to ticketed events. In various particular embodiments, the devices, systems or methods may involve one or more devices in communication over a network. Such devices, systems, and methods may facilitate the selection and purchase of tickets to various ticketed events and exchanging activities associated with purchased tickets.

Ticket exchanging activities (sometimes referred to herein as ticket swapping or ticket swapping activities) may, according to some embodiments, include pre-event ticket exchanging activities, event-concurrent ticket exchanging activities, or other ticket exchanging or swapping activities in which a ticketholder exchanges one or more tickets for a ticketed event for one or more other tickets for that event or another event. In various circumstances, a user of a ticket exchange system may swap (exchange) a high-value ticket for a lower value ticket and other compensation, a high-value ticket for multiple lower value tickets, a low value ticket for a high value ticket for an additional cost, multiple low value tickets for a high value ticket, a ticket for another ticket in an even swap, or one or more tickets for one or more other tickets or goods and/or services.

Although many of the examples described herein are discussed in the context of exchanging (sometimes referred to herein as swapping) tickets, it will be appreciated by one skilled in the art that the systems and methods described herein may be applied to exchanging of any goods and/or services. For example, a user of an exchange system may be provided with the ability to exchange a good or service other than a ticket (e.g., a motorcycle, a baseball bat, a guitar, or a hat) for another good or service other than a ticket (e.g., a vacation home rental, a cleaning service, a bicycle, or a meal at a restaurant). The system and/or swap-enabled users of the system may generate exchange offers that may be provided to a user of the system.

While the various examples disclosed herein focus on particular aspects regarding the online sale, purchase and/or (sometimes referred to herein as swapping) of tickets, it will be understood that the various inventive principles and embodiments disclosed herein may be applied to other types of ticketed applications and arrangements as well. For example, a ticket exchange that is performed in person or on a closed or proprietary computing system may utilize one or more of the aspects and features found in the various systems and methods provided whereby the transaction is originated, communicated, messaged, alerted, notified, tracked, recorded, arranged, or otherwise facilitated by the system or method.

Reference throughout the specification to “various embodiments,” “some embodiments,” “one embodiment,” “an embodiment,” “various examples,” “one example,” “an example,” or “some examples” means that a particular feature, structure, or characteristic described in connection with the embodiment or example is included in at least one embodiment. Thus, appearances of these are not necessarily all referring to the same embodiment. Furthermore, the particular features, structures or characteristics may be combined in any suitable manner in one or more embodiments.

According to an embodiment, a computer program product may comprise a non-transitory machine readable medium. The non-transitory machine readable medium may have computer readable and executable code for instructing one or more processors to perform any of the methods disclosed herein.

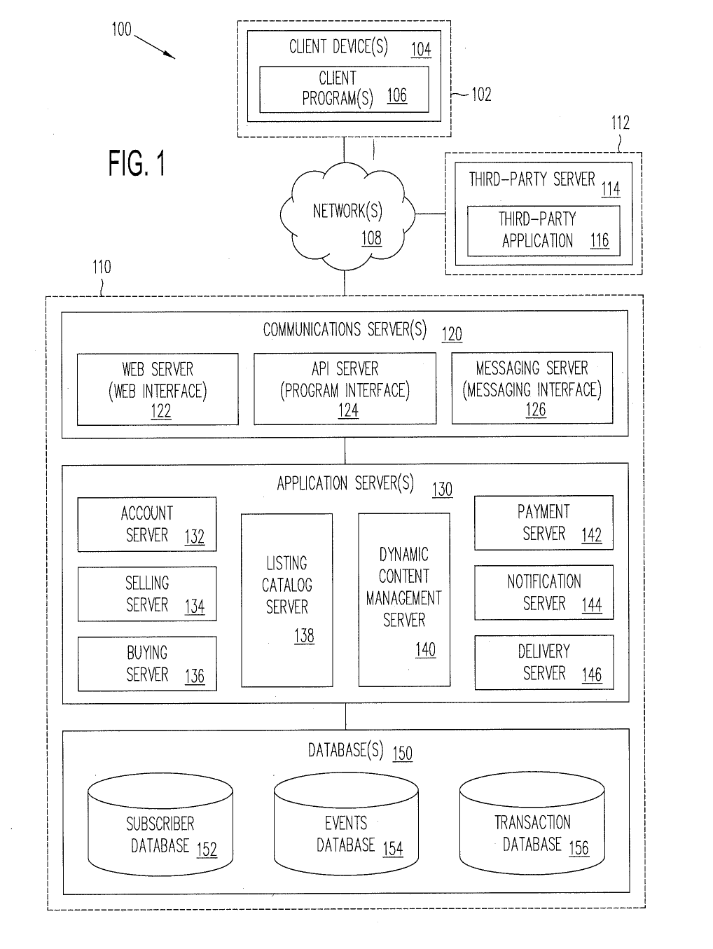

Beginning with FIG. 1, some embodiments of a computing system are adapted for implementing the selection and purchase of tickets for ticketed events and/or the exchange of tickets for ticketed events is illustrated in block diagram format. As shown, a computing system 100 may comprise or implement a plurality of servers and/or software components that operate to perform various methodologies in accordance with the described embodiments. Example servers may include stand-alone and enterprise-class servers operating a server OS such as a MICROSOFT® OS, a UNIX® OS, a LINUX® OS, or other suitable server-based OS. It may be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 may include, among various devices, servers, databases and other elements, a client 102 that may comprise or employ one or more client devices 104, such as a laptop, a mobile computing device, a PC, and/or any other computing device having computing and/or communications capabilities in accordance with the described embodiments. In particular, it is specifically contemplated that client devices 104 may include a cellular telephone or other similar mobile device that a user may carry on or about his or her person and access readily.

Client devices 104 generally may provide one or more client programs 106, such as system programs and application programs to perform various computing and/or communications operations. Example system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Example application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 may be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 (e.g., a communications session for exchange, sale, and/or purchase of tickets for a ticketed event) may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 may take place, as will be readily appreciated. In particular, wireless communications of any suitable form may take place between client 102 and system 110, such as that which often occurs in the case of mobile phones or other personal mobile devices.

In various embodiments, computing system 100 may include, among other elements, a third party 112, which may comprise or employ a third-party server 114 hosting a third-party application 116. In various implementations, third-party server 114 and/or third-party application 116 may host a web site associated with or employed by a third party 112. For example, third-party server 114 and/or third-party application 116 may enable network-based system 110 to provide client 102 with additional services and/or information, such as additional ticket inventory. Third-party server 114 and/or third-party application 116 may provide system 110 and/or client 102 with email services and/or information, social networking services and/or information, travel services and/or information, purchase services and/or information, or other online services and/or information.

In one embodiment, third party server 112 may include a social networking server that hosts a user's social network account. In another embodiment, third party server 112 may include an email server that hosts a user's email account. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 may include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It may be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, exchanging services, swapping services, delivery services, payment services, gathering services, and notification services. Application servers 130 may include an account server 132, a selling server 134, a buying server 136, a listing catalog server 138, a dynamic content management server 140, a payment server 142, a notification server 144, and/or a delivery server 146 structured and arranged to provide such online marketplace and ticket fulfillment and/or exchange services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

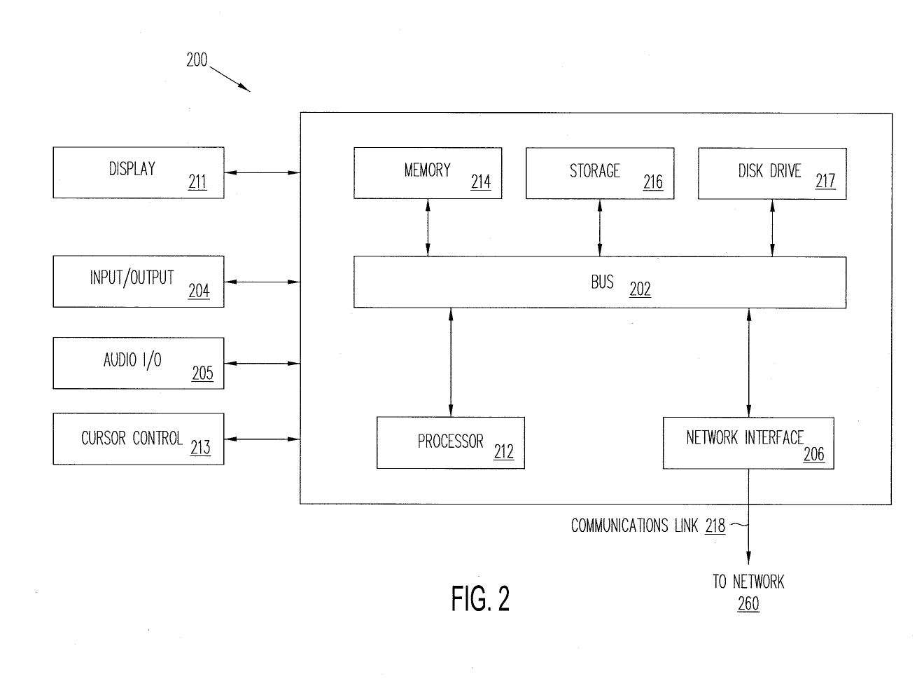

Continuing with FIG. 2, an example of a computer system 200 suitable for implementing on one or more devices of the computing system in FIG. 1 is depicted in block diagram format. In various implementations, a device that includes computer system 200 may comprise a personal computing device (e.g., a smart or mobile phone, a computing tablet, a personal computer, laptop, PDA, Bluetooth device, key FOB, badge, wearable computing devices, such as smart watches and glasses, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Additionally, as more and more devices and articles become communication-capable, such as sensors using wireless communication to report, track, message information and so forth, these devices may be part of such transactions. For example, a user has a jacket with a sensor or communication device embedded in the jacket, and the jacket may communicate with other devices to identify potential exchanges or transactions based on the proximity of the wearers or owners. In one example, a first user's jacket may have information as to ticket holdings of the first user and may detect ticket holding information of another user, the second user. Detecting this information may prompt the first user to initiate a trade or an offer for a trade with the second user.

Computer system 200 may include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, a venue server, an email server, a social networking server, other third-party servers, and/or a payment provider server via a network. In various embodiments, such as for many cellular telephone and other mobile device embodiments, this transmission may be wireless, although other transmission mediums and methods may also be suitable. A processor 212, which may be a micro-controller, digital signal processor (DSP), or other processing component, processes these various signals, such as for display on computer system 200 or transmission to other devices over a network 260 via a communication link 218. Again, communication link 218 may simply be a wireless communication form in some embodiments. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory machine-readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof may be used to implement an exchange or a swapping operation for goods and/or services such as tickets.

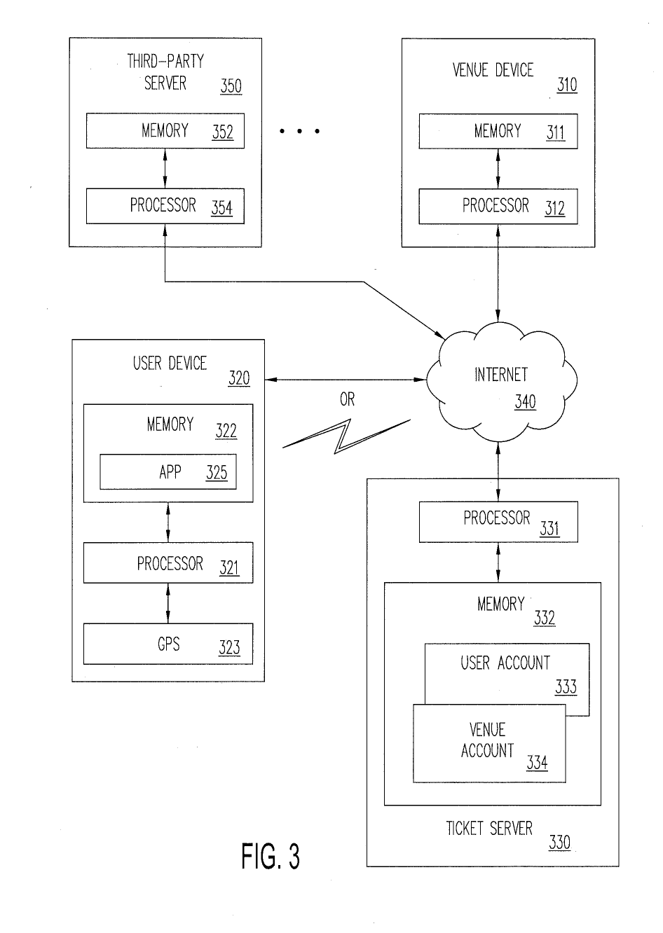

FIG. 3 is a block diagram showing a ticket selection and purchase system that may be used to facilitate exchange operations such as ticket exchange operations, according to an embodiment. As shown in FIG. 3, a ticket server 330 may be in communication with one or more user devices such as user device 320, one or more venue devices such as a venue device 310, and one or more third-party servers such as a third-party server 350.

In some embodiments, a venue device such as venue device 310 may be present at each of a plurality of different event venues (e.g., stadiums, theaters, arenas, amphitheaters, or other venues at which ticketed events are held). Venue device 310 may provide information regarding events scheduled to occur at a particular venue and regarding seating at that venue. In some embodiments, venue device 310 may provide the information to ticker server 330. Ticket server 330 may obtain information regarding events scheduled to occur at various venues and information regarding seating at the various venues from one or more venue devices 310, from other sources, or ticket server 330 may have a database of event information and venue information independent of any interaction with a venue device. Ticket server 330 may, for example, be an implementation of system 110 of FIG. 1.

Venue device 310 may be a computer, a server, a computing tablet, or a mobile device, as examples. Venue device 310 may have processing circuitry such as a processor 312 and storage such as a memory 311. Processor 312 may execute a software program stored in memory 311 for providing information regarding events scheduled to be at the venue and regarding seating at the venue for each scheduled event. Venue device 310 may provide the information to the ticket server and/or to a user device such as user device 320.

Venue device 310 may be disposed at the venue. However, this is merely illustrative. If desired, venue device 310 may be disposed at a location other than the venue. Each venue may have a dedicated venue device 310 or a plurality of different venues may share a common venue device 310. For example, co-owned venues may share a common venue device 310.

In some embodiments, venue device 310 may be omitted if ticket server 330 has the information needed for buying, selling, and exchanging of tickets. For example, ticket server 330 may have a database of available tickets and information about the tickets and venues that enables ticket server 330 to provide the necessary information to a user for purchasing and/or exchanging tickets for events at venues.

Third party servers such server 350 may include, for example, a social media server that hosts one or more social networking accounts (e.g., a social networking account for a user of user device 320), an email server that hosts email services (e.g., an email account for the user), and/or another server. A user may use user device 320 to access ticket server 330 to select and purchase tickets for ticketed events from ticket server 330, to sell tickets for ticketed events, to purchase tickets for events at a venue and/or exchange (swap) tickets or other goods and/or services (as examples).

Third party server 350 may be a computer, a server, a computing tablet, or a mobile device, as examples. Server 350 may have processing circuitry such as a processor 354 and storage such as a memory 352.

In one embodiment, server(s) 350 may be omitted if ticket server 330 has the information needed for exchanging tickets. For example, ticket server 330 may have a database of purchases and/or user device information gathered from user device 320 that indicates tickets the user has purchased, interests of the user, calendar information of the user, travel information of the user, purchase history information of the user, or other user or ticket, event, venue, artist, team or other information associated with the context in which the tickets are bought and sold.

A user (e.g., a potential ticket swapper) may use a device such as user device 320 to shop online for available tickets and/or exchange purchased tickets for one or more events. User device 320 may be a mobile device such as a cellular telephone, a tablet computer, a laptop computer, or another portable computing device. User device 320 may be a non-mobile device such as a home (land line) telephone, a desktop computer, an interactive set top box, or the like. User device 320 may be any device or combination of devices that facilitate online ticket purchasing and/or exchanging. User device 320 may, for example, be an implementation of client device 104 of FIG. 1.

User device 320 may have a processor 321, a memory 322, a global positioning system component (GPS) 323 and/or other suitable device components. Processor 321 may execute an application such as an app 325 that facilitates the ticket selection, purchase, and/or exchange methods disclosed herein. App 325 may be stored in a memory 322. App 325 may provide a graphical user interface (GUI) for the user when the user is selecting, purchasing, and/or exchanging tickets or other goods and/or services online. If desired, app 325 may be a dedicated ticket purchasing app. However, this is merely illustrative. In some configurations, app 325 may be part of another app, such as a Paypal, Inc. payment provider app.

User device 320 may communicate with venue device 310, third-party server 350, and/or ticket server 330 via a network, such as the Internet 340. User device 320 may communicate with the Internet via either a wired connection or a wireless connection. App 325 may be configured to transmit to ticket server 330 location information of user device 320. For example, ticket server 330 may have access to location information for a user based on location data from GPS 323.

Ticket server 330 may be operated by an online ticket seller such as StubHub, Inc. Ticket server 330 may facilitate online ticket sales and/or online ticket exchanges (sometimes referred to herein as ticket swaps). Ticket server 330 may include processing circuitry such as a processor 331 in communication with storage such as a memory 332. Processor 331 may include one or more processors. Processor 331 may access accounts such as a user account 333 and/or a venue account 334 that are stored in memory 332. User account 333 may include information regarding the user (e.g., identification information, preferences, account numbers, purchase history, social network contacts, email contacts, email account permissions, social media account permissions, purchased-ticket event information, attended event information, etc.). Venue account 334 may include information regarding the venue (e.g., information regarding events, seating, venue location, and other venue features). Memory 332 may be separate from the ticket server and may be used to store any number of user accounts 333 and venue accounts 334. Memory 332 may be distributed, e.g., have portions thereof disposed at a plurality of different locations. Other accounts may also be accessible by processor 331, such as accounts of users selling or exchanging tickets that include ticket details, such as price, quantity, location, and event information, and financial information that enable funds to be deposited into or drawn from seller accounts when their tickets are sold or exchanged.

Ticket server 330 may include one or more servers located at one or more locations. Thus, the ticket server 330 may be geographically and operationally distributed if desired. Ticket server 330 may be part of another system, such as a payment provider system. Venue device 310 and/or third-party server 350 may communicate with ticket server 330 over a wired or wireless connection such as via a network, such as Internet 340. Venue device 310 and/or third-party server 350 may communicate with a plurality of different ticket servers 330. Ticket server 330 may communicate with a plurality of different venue devices 310 and/or third-party servers 350. A plurality of different ticket servers 330 may communicate among themselves and may be considered herein as being the same as a single ticket server 330. The user may operate user device 320 to interact with ticket server 330 so that the user may select, purchase, sell and/or swap tickets online.

Ticket server 330 may communicate with venue device 310 to obtain information about the venue. For example, ticket server 330 may communicate with venue device 310 to obtain information regarding the scheduling of events at the venue and regarding features of the venue. The features of the venue may be dependent upon the events of the venue, e.g., the features of the venue may vary from event to event. Generally, venue device 310, mobile device 320, third-party server 350, and ticket server 330 may perform functions discussed herein. That is, at least to some extent, a function that is discussed herein as being performed via a particular one of these devices may be performed by a different one of these devices, by a combination of these devices, and/or by other devices.

Venue device 310, user device 320, third-party server 350, other mobile devices, and server 330 may communicate with one another via a network, such as the Internet 340, or with one another via one or more networks, such as local area networks (LANs), wide area networks (WANs), cellular telephone networks, and the like. Venue device 310, mobile devices such as user device 320, third-party server 350, server 330, and other devices may communicate with one another, at least partially, via one or more near field communications (NFC) methods or other short range communications methods, such as infrared (IR), Bluetooth, WiFi, and WiMax.

When a user wishes to shop for tickets online, resell tickets online, check in to an event venue online, access electronic tickets online, or exchange tickets online (as examples), the user may open an online ticket seller's website or may access the ticket seller using an application such as app 325. The user may open the ticket seller's website using user device 320, for example. The ticket seller's website may be hosted on ticket server 330, venue device 310, or on any other server or device.

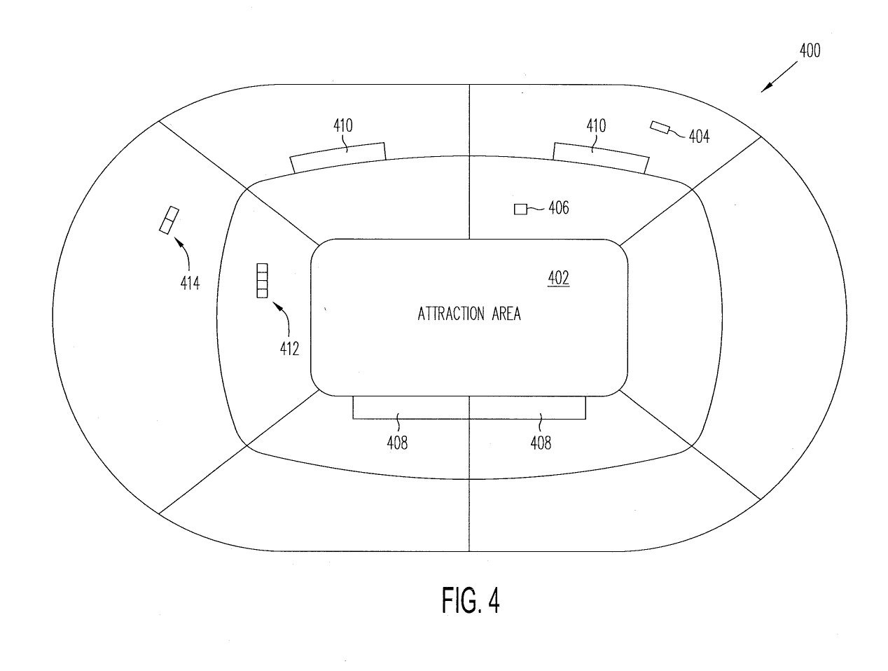

FIG. 4 is a diagram of an event venue showing various seat locations and types in accordance with an embodiment. As shown in FIG. 4, a venue 400 may include an attraction area 402. Attraction area 402 may be a stage, a court, a field, a track, a rink, a pool, or any other area in which events are presented, enacted, or competed (as examples). Venue 400 may include various locations from which attraction area 402 may be viewed and to which access is controlled based on tickets. For example, venue 400 may include seats, standing areas, luxury boxes, or other attraction viewing areas. In the example, of FIG. 4, venue 400 includes a seat 406 located relatively near to attraction area 402 and a seat 404 located relatively far from attraction area 402. Seat 406 may have a value that is higher than the value of seat 404 due to the relatively closer proximity to area 402 of seat 406. In some circumstances, a holder of a ticket for seat 406 may desire to exchange that ticket for a ticket for seat 404 and vice versa. For example, the holder of a ticket for seat 404 may desire to sit closer to attraction area 402 for some or all of an event and the holder of the ticket for seat 406 may wish to exchange the relatively higher value ticket for seat 406 for a ticket for seat 404 and additional compensation or for the opportunity to sit close to a friend.

In another example, two people may have tickets for a pair of seats 414 and may desire to sit with friends that have tickets for a pair of seats in a group of seats 412. The seat 414 ticketholders may notify a ticket seller system of their desire to exchange their seats 414 for seats near their friends. The owners of the other two seats in group 412 may be notified by the ticket seller system that someone wishes to exchange tickets. The seat 414 ticketholders may offer additional compensation to the holders of the other two tickets in group 412 such as additional funds, additional tickets for that event or another event, or other compensation. In one embodiment, the holders of the other two tickets in group 412 may be provided with a one-click swap offer that, when accepted, exchanges the tickets and transfers funds from an account associated with the seat 414 ticketholders to an account associated with the holders of the other two tickets in group 412.

Venue 400 may include other types of seats such as season ticket seats 408 and/or luxury boxes 410. A ticket seller system may provide season ticket holders, luxury box ticketholders and/or others with the ability to buy, sell, and/or exchange some or all of a season ticket package or a luxury box package. For example, the owner of tickets for one or more season ticket seats 408 may exchange tickets for one of the events in the season for tickets to another event, another type of event, another type of seat, or any other type of goods or services. In another example, the owner of ticketed access to a luxury box for an event may exchange some or all of the ticketed access to the luxury box for tickets for another event, another type of event, another type of seat, or any other type of goods or services.

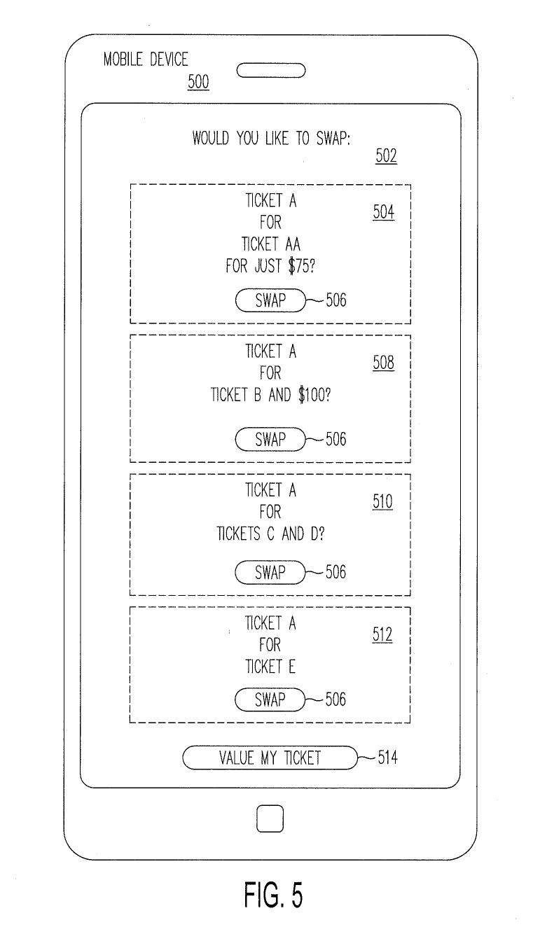

FIG. 5 shows an example of a way in which various types of ticket swap offers (sometimes referred to herein as ticket exchange offers) may be provided to a user of a system for exchanging tickets according to an embodiment. As shown in FIG. 5, one or more exchange offers such as ticket swap offers may be provided to a user on a user device such as mobile device 500. A ticket swap offer such as ticket swap offers 504, 508, 510, and/or 512 may be provided in a window 502 on a display of mobile device 500. For example, window 502 may be a pop up window generated by an application such as app 325 (see, e.g., FIG. 3) running on device 500. However, this is merely illustrative. If desired, window 502 may be a portion of a ticket seller website that the user has logged into or may be otherwise generated on a display of mobile device 500 as would be understood by one skilled in the art.

As shown in FIG. 5, ticket swap offers that may be made to a user of, for example, a ticket seller system may include an upgrade swap offer 504 for a relatively higher value ticket, a downgrade swap offer such as swap offer 508 or 510 for a relatively lower value ticket and additional compensation, and/or an even swap offer 512. Each swap offer may include a swap acceptance icon such as a virtual SWAP button 506 that transmits a request to initiate an exchange to a ticket exchange system as described herein. SWAP button 506 (or any equivalent exchange selection icon or mechanism) may be selected by a user by selecting the SWAP button (e.g., using a finger or other instrument on a touch screen or using a mouse-controlled or touchpad-controlled cursor). SWAP button 506 may cause a ticket server or an application running on mobile device 500 to open an additional window into which payment and/or delivery information may be entered for a selected exchange or SWAP button 506 may be a one-click swap button that, when clicked or tapped, fully completes an exchange transaction for the user including exchanging swapped tickets between swapping parties and transferring any funds associated with the exchange between swapping party accounts (e.g., by debiting or a crediting one or more accounts of the swapping parties based on the relative values of one or more attributes of the tickets). In general, any number of swap offers may be presented to a user in a particular swap offer window 502. Swap offers presented to the user may be determined based on the value of the one or more attributes of one or more ticket or tickets owned by the user, ticket resale market conditions, user information such as user schedule information, event information such as news about an artist associated with an event (e.g., a lead role being played by an understudy, a special guest known to be of interest to the user) or other ticket context information.

Each ticket may have one or more attributes such as a price, a date (e.g., an event date), a seat, a section, an event name, an event type, an artist, a team, or other attribute. Each attribute of a ticket may have an associated value. For example, the value of a price attribute may be a dollar value of the ticket. As another example, the value of a seat attribute may be the location within the venue of the seat. As another example, the value of a date attribute may be the time of year, day of the week, portion of a season, or other date information that may be of value to one or more users. The value of an attribute may be determined for an average user, a group of users, or for a particular user. For example, a ticket exchange system may determine (e.g., via communication from the user or by system learning based on user habits or purchases) that one particular user is more interested in a low price than a preferred seat location, that another particular user is more interested in events on weekends than a low price, and yet another particular user is more interested in a preferred seat location than a low price or a preferred date.

A ticket exchange offer (e.g., a swap offer) may be generated and/or provided to a user based on any combination of one or more attributes and/or one or more values of those attributes. For example, ticket exchange system may identify a first item of a user, the first item having a first value of a first attribute, identify a second item to the user, the second item having a second value of a second attribute, and facilitate exchange for the user of the first item for the second item. In situations in which the first attribute is the same as the second attribute, then the system may determine a difference in the first and second values and calculate a debit or a credit to be made to an account of the user based on the difference in the first and second values. In situations in which the first attribute is different from the second attribute, then the system may determine a difference in the first and second attributes and calculate a debit or a credit to be made to an account of the user based on the difference in the first and second attributes.

In one example, the first item may be a first event ticket, the first attribute may be a price of the first event ticket, the second item may be a second event ticket and the second attribute may be a price of the second event ticket. In this example, the monetary value of the price of the first event ticket may be greater than the monetary value of the price of the second ticket. The system may calculate a difference in the prices, offer an exchange of the second item (e.g., the second event ticket) for the first item (e.g., the first event ticket) to the user, the offer identifying the difference in value, receive a request to initiate the exchange, facilitate the exchange of the second item for the first item to the user, and processes a credit to the user as a function of the difference in value.

Upgrade swap offer 504 may include text prompting the user to determine whether they wish to swap a ticket A for a relatively higher value ticket AA for an additional cost (e.g., $75). The additional cost may be determined based on the relative prices of ticket A and ticket AA and/or the relative values of one or more other attributes of the ticket A and ticket AA. Tickets A and AA may be tickets for the same event or for different events. In one example scenario, ticket A may be a 10^{th} row ticket for a concert and ticket AA may be a front row ticket for that concert. In another example scenario, ticket A may be a front row ticket for a basketball game and ticket AA may be a front row ticket for another basketball game or a fifth row ticket for a ballet.

In order to assist the user in determining whether or not to swap tickets, window 502 may include a VALUE MY TICKET virtual button 514. In response to the user selecting virtual button 514, the user may be presented with an estimated current monetary value of their ticket based on (as examples) an average of current seat sales or offers for similar seats.

Downgrade swap offers 508 and 510 may include text prompting the user to determine whether to exchange a ticket A for a relatively lower value ticket and additional compensation. Swap offer 508 includes an offer to exchange ticket A for a relatively lower value ticket B and a payment of $100 (as an example). The payment of $100 may be transferred to the user from another user account, from a ticket seller account or may be provided to another account of the user's choosing such as a charity or political fund. Ticket B may be another ticket for the same event or a ticket for another event. The payment amount of $100 may be determined based on the relative values of tickets A and B to the user and other ticket context information.

Swap offer 510 includes an offer to exchange ticket A for multiple relatively lower value tickets C and D. In some situations, tickets C and D may be tickets that are further away from the attraction area or tickets for another event at a less desirable time or on a less desirable date in general or for the user. In other situations, tickets C and D may be monetarily higher value tickets that are relatively less valuable to the user based on non-monetary considerations. For example, the user may be unable to attend the event for which tickets C and D are provided and may be able to trade two relatively higher monetary value tickets for one relatively lower monetary value ticket and the ability to still attend an event.

Even swap offer 512 may include text prompting the user to determine whether to exchange ticket A for another ticket E of equal value. As discussed herein, the relative values of the tickets may be determined based solely on monetary valuation or may be determined based on one or more other ticket context considerations (e.g., values of ticket attributes or other context information) that are particular to the tickets and/or to the user.

The ticket swap offers of FIG. 5 may be presented to the user prior to the event for which the user holds tickets. In some embodiments, swap offers may be made to a user during a ticketed event.

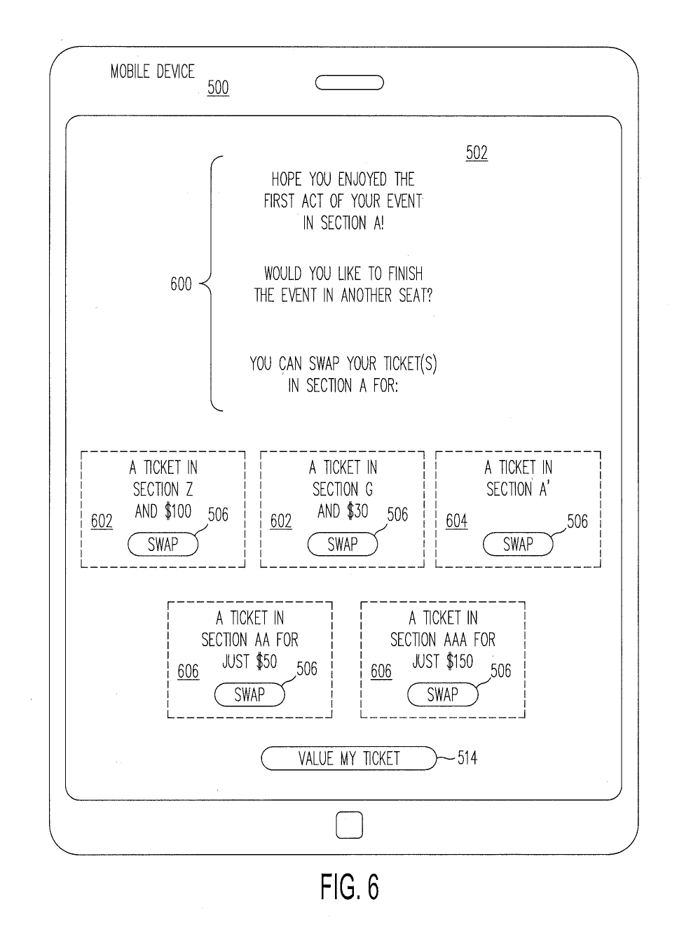

FIG. 6 shows examples of various swap offers that may be made to a user during a ticketed event that the user is attending. In the example of FIG. 6, swap offer window 502 includes text 600 stating “HOPE YOU ENJOYED THE FIRST ACT OF YOUR EVENT IN SECTION A! WOULD YOU LIKE TO FINISH THE EVENT IN ANOTHER SEAT? YOU CAN SWAP YOUR TICKET(S) IN SECTION A FOR:” and alerting the user of various opportunities to exchange a ticket in a section A for one or more other tickets. In various scenarios, a user may wish to move to a seat relatively closer to the attraction area, move to a seat relatively further from the attraction area (thereby allowing another fan to sit in the closer seat and, if desired, making a profit), or move to a similarly valued seat in another section (e.g., a section with a different view of the attraction or a section in which the user's friends or other acquaintances are located).

As shown in FIG. 6, event-concurrent swap offers may also include downgrade swap offers such as swap offers 602 (e.g., an offer to exchange the user's ticket in section A for a ticket in section Z and $100 or an offer to exchange the user's ticket in section A for a ticket in section G and $30), even swap offers such as swap offer 604 (e.g., an offer to exchange the user's ticket in section A for a similarly valued ticket in section A′), and upgrade swap offers 606 (e.g., an offer to exchange the user's ticket in section A for a ticket in section AA for an extra $50 or an offer to exchange the user's ticket in section A for a ticket in section AAA for an extra $150).

Swap offer window 502 may also include a VALUE MY TICKET virtual button 514 that, when clicked, presents the user with the value of their ticket at that time during the event. It should be appreciated that the swap offers shown in FIG. 6 are merely illustrative and a system of the type described herein may provide users with the ability to exchange any tickets or other goods or services for other tickets, goods, and or services.

A system for the purchase, sale, and/or exchange of tickets or other goods and services may track or monitor various aspects of a ticket context associated with a particular ticket, event, venue, and/or user. The monitored ticket context may be used to determine the value of a ticket and/or the value of one or more attributes of the ticket, to determine the value of one or more tickets, ticket attributes, or other goods or services to a particular user, and/or to determine which offers to send to a ticket holder. For example, the system may track the monetary value of tickets for various events (e.g., based on a current or trending resale value of similar tickets), track the personal calendar of a user (e.g., a calendar on the user's phone or other mobile device), track the travel of a user (e.g., based on the user's emails, social network postings, personal webpage content and/or purchase history), or track other aspects of the context of the tickets. A swap offer may be generated for a user based on the monitored ticket context. In one example, an alumni of a university is prompted to exchange a current ticket holding for an up-coming event of the university, wherein the ticket exchange system acts as one form of notification for events and status of university activities.

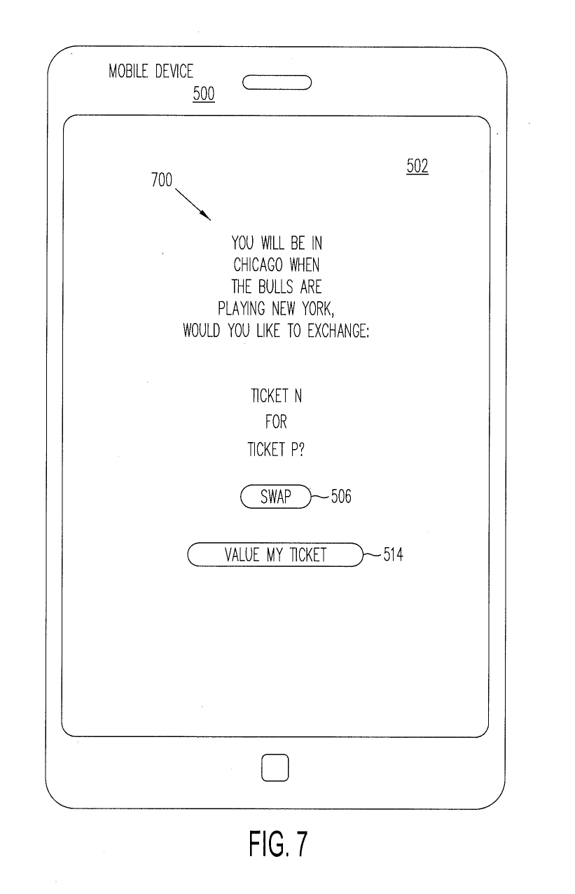

FIG. 7 shows an example of a swap offer that may be generated based on a monitored ticket context such as a determined travel schedule of a user. As shown in FIG. 7, a swap offer 700 may be presented in offer window 502. Swap offer 700 may be generated when a system such as system 100 of FIG. 1 determines (e.g., based on the user's calendar, purchase history, email, social media accounts, etc.) that a user of the system will be travelling to Chicago. Swap offer 700 may include text such as “YOU WILL BE IN CHICAGO WHEN THE BULLS ARE PLAYING NEW YORK, WOULD YOU LIKE TO EXCHANGE: TICKET N FOR TICKET P?”. As an example, the user may live in Los Angeles and hold a ticket N for a Los Angeles Lakers basketball game. When the system determines that the user will be in Chicago on the day of the Lakers game, the system may provide offer 700 for a ticket P for a Bulls game on the same day. In this way, the user may be provided with the opportunity to use the value of ticket N for another game without the potential inconvenience and extra cost of having to sell ticket N and search out a new event and ticket P for the event.

Although the swap offers of FIGS. 5, 6, and 7 are shown as being generated on a mobile device, it should be appreciated that swap offers of the types described herein may be presented to a user on other types of computing devices such as non-mobile computing devices, laptop devices, tablet devices, desktop devices or the like.

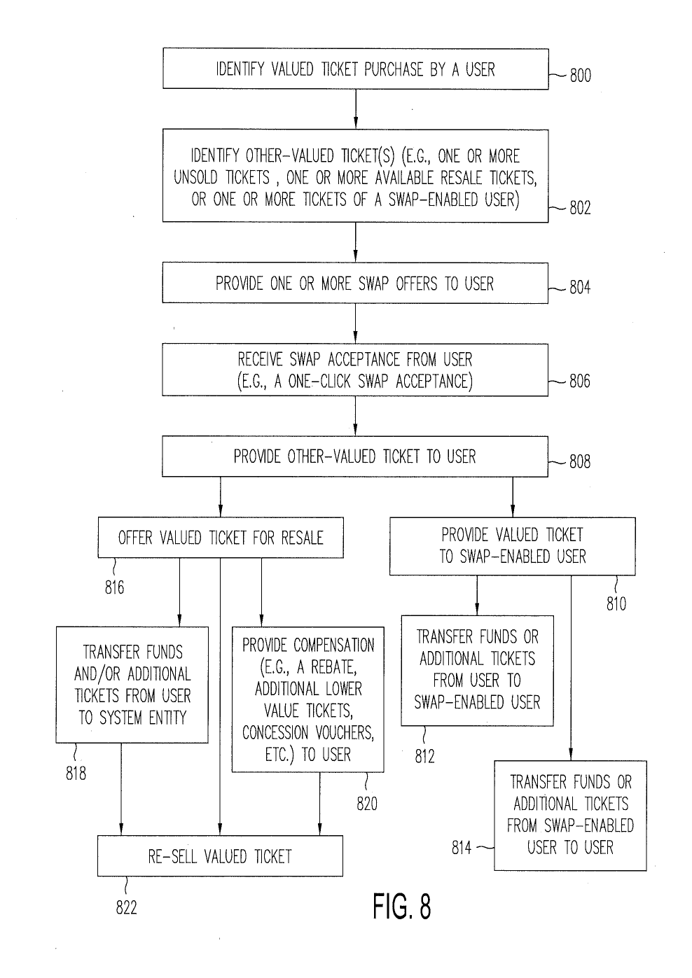

Illustrative steps that may be used in generating and/or providing a swap offer to a user are shown in FIG. 8. As discussed above, as connectivity of devices expands, there will be a variety of ways for notification, suggestion, messaging, prompting and other actions to initiate and facilitate an exchange transaction.

At step 800, a system of the type shown in, for example, FIGS. 1 and/or 3 may identify a valued ticket purchase by a user of the system. The system may identify the valued ticket purchase based on the user's interaction with the system during purchase of the valued ticket (e.g., from a ticket server), based on the user's email, based on the user's purchase history, based on social media accounts of the user or though other suitable means. The valued ticket may be a relatively high valued ticket (e.g., a front row ticket, a season ticket, a luxury box ticket, a lower level ticket, a floor ticket, or any ticket that has a relatively higher value than another ticket), a relatively low valued ticket (e.g., a ticket for a seat in an upper or rear section of a venue or any ticket that has a relatively lower value than another ticket), or a moderately valued ticket (e.g., a ticket having a value near the average ticket value).

At step 802, the system may identify one or more other-valued tickets such as one or more unsold tickets, one or more available resale tickets, or one or more tickets of a swap-enabled user. The other-valued ticket or tickets may have a relatively higher value, a relatively lower value than the valued ticket identified at step 800 or may have the same or similar value. A swap-enabled user may be another user of the system that has enabled swap alerts and/or that has notified the system that they desire to exchange their tickets for other tickets.

At step 804, the system may provide one or more swap offers to the user. The swap offers may include an offer to the user to exchange the valued ticket for the other-valued ticket and, in some circumstances, additional compensation or at an additional cost as described herein in connection with, for example, FIGS. 4-8.

At step 806, the system may receive a swap acceptance (e.g., a request to initiate an exchange) from the user (e.g., a one-click swap acceptance when the user clicks or otherwise selects on a one-click swap acceptance button).

At step 808, the other-valued ticket may be provided to the user in exchange for the valued ticket. The other-valued ticket may be provided electronically, a physical ticket may be delivered to the user, or a ticket may be provided at a pick-up center.

In some circumstances the other-valued ticket may be owned by an entity associated with the system (e.g., a ticket seller) or by the venue. In other circumstances, the other-valued ticket may be owned by another user of the system such as a swap-enabled user. In circumstances in which the other-valued ticket is owned by another user, the system may proceed to step 810. In circumstances in which the other-valued ticket is owned by the entity associated with the system or by the venue, the system may proceed to step 816.

At step 810, the system may facilitate the exchange of the other-valued ticket for the valued ticket at least in part by providing the valued ticket to the other user (e.g., the swap-enabled user), thereby swapping the valued ticket for the other-valued ticket. In circumstances in which the valued ticket has a relatively lower value (e.g., based on the relative values of one or more attributes) than the other-valued ticket (e.g., in an upgrade ticket swap for the user), the system may proceed to step 812. In circumstances in which the valued ticket has a relatively higher value than the other-valued ticket (e.g., in a downgrade ticket swap for the user), the system may proceed to step 814. In other circumstance, the system may complete an even ticket swap at step 810 and take no further action.

At step 812, the system may transfer funds and/or additional tickets from the user to the swap-enabled user (e.g., by debiting an account of the user and crediting an account of the swap-enabled user based on the based on the relative values of one or more attributes), thereby compensating the swap-enabled user for the relatively higher valued ticket in the ticket swap. In this way, the system may be considered an exchange market, where ticket values float and are recognizable by users through the market.

At step 814, the system may transfer funds and/or additional tickets from the swap-enabled user to the user (e.g., by crediting an account of the user and debiting an account of the swap-enabled user based on the based on the relative values of one or more attributes), thereby compensating the user for the relatively higher valued ticket in the ticket swap.

At step 816, the system may offer the valued ticket for resale. In this way, the user may exchange the valued ticket for a ticket that has not yet been purchased or that is owned by an entity associated with the system or the venue.

At step 822, the system may re-sell the valued ticket (e.g., at a higher price than was originally paid). Before or after re-selling the valued ticket, the system may transfer funds or additional tickets from the user to the system (e.g., to the venue) at step 818 or provide compensation (e.g., a rebate, additional lower value tickets, concession vouchers, etc.) to the user at step 820. However, steps 818 and 820 are merely illustrative. In circumstances in which the valued ticket and the other-valued ticket have a similar or same value, the system may proceed to step 822 without receiving or providing any additional compensation to or from the user.

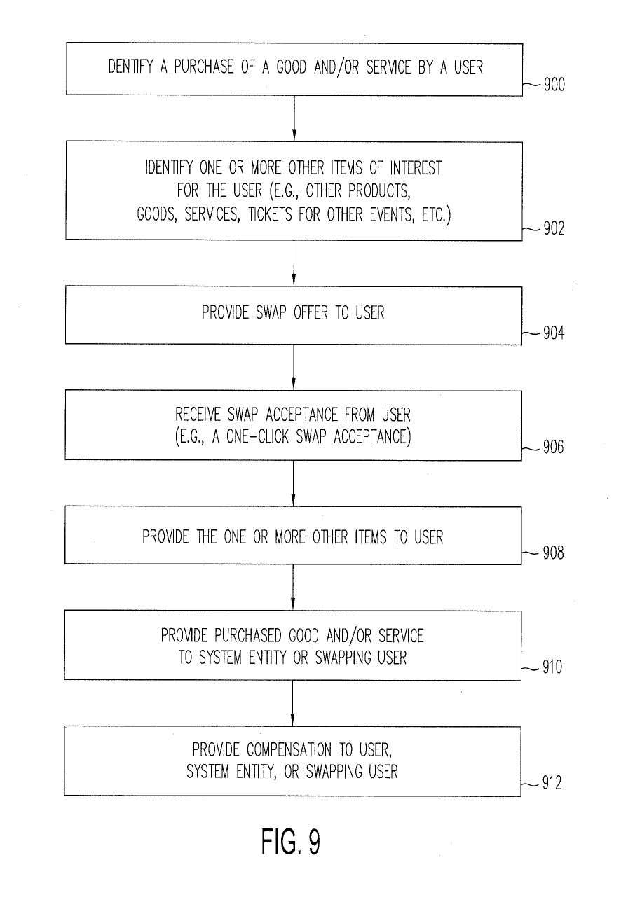

A system of the type shown in, for example, FIGS. 1 and/or 3 may be used to provide users with the ability to exchange goods and/or services other than tickets. FIG. 9 is a flowchart of illustrative steps that may be used in swapping goods and/or services.

At step 900, a purchase of a first item such as good and/or a service by a user may be identified.

At step 902, a second item such as one or more other items of interest for the user may be identified. Other items of interest may include other products, other goods, other services, tickets for other events, etc.

At step 904, a swap offer may be provided to the user. The swap offer may include text prompting the user to determine whether they would like to exchange the purchased good and/or service for one or more of the identified items of interest. Prior to providing the swap offer, the system may calculate a difference between the values of one or more attributes of the first and second items and generate the swap offer based the calculation.

At step 906, a swap acceptance (e.g., a request to initiate the exchange) may be received from the user. The swap acceptance may be, for example, a one-click swap acceptance provided with the user clicks a virtual one-click swap acceptance button as described herein.

At step 908, the one or more other items of interest may be provided to the user.

At step 910, the purchased item may be provided to an entity associated with the system or a swapping user. Steps 910 and 912 may serve to facilitate the exchange of the second item for the first image to the user.

At step 912, additional compensation may optionally be provided to the user, the entity associated with the system, and/or the swapping user to complete the exchange.

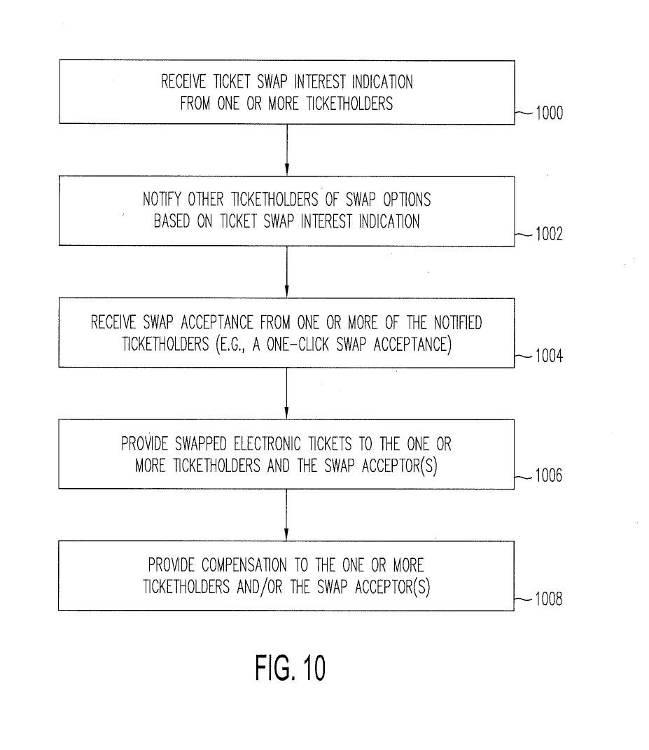

In some circumstances, a user may wish to initiate an exchange such as a ticket swap rather than waiting for a swap offer from the system. For example, a user may have one or more tickets for an event that the user's friends are also attending. However, the user's seats associated with the tickets may be located in a different area of the event venue from the seats of the user's friends. The user may therefore wish to initiate an exchange so that the user can sit near the user's friends during the event. Illustrative steps that may be involved in providing a user with the ability to initiate a ticket swap are shown in FIG. 10.

At step 1000, the system may receive a ticket swap interest indication from one or more ticketholders. For example, the user may provide an indication to the system that they wish to exchange two tickets in section Q for two tickets in section R. The ticket swap interest indication may also include information indicating that the user is willing to provide additional compensation with the two tickets in section Q or that the user wishes to receive additional compensation with the two tickets in section R.

At step 1002, the system may notify other ticketholders of swap options based on the ticket swap interest indication. For example, the system may identify ticketholders with tickets in section R and provide a swap offer for the tickets in section Q to those identified ticketholders.

At step 1004, the system may receive a swap acceptance offer from one or more of the notified ticketholders (e.g., a one-click swap acceptance).

At step 1006, the system may provide swapped electronic tickets to the one or more ticketholders and the notified ticketholders that accepted the swap offer (e.g., the swap acceptor(s)). For example, the system may provide an electronic version of the tickets in section Q to the swap acceptor(s) and provide an electronic version of the tickets in section R to the one or more ticketholders.

At step 1008, the system may provide compensation to the one or more ticketholders and/or the swap acceptors (e.g., by transferring funds between an account of the one or more ticketholders and an account of the swap acceptor(s)).

In various embodiments, a swap offer that is provided to a user may be triggered by a monitored context of the ticket. Illustrative steps that may be involved in providing a ticket swap offer based on a monitored ticket context are shown in FIG. 11.

At step 1100, a ticket purchase by a user may be identified.

At step 1102, the ticket context (e.g., one or more ticket attributes, the value of one or more ticket attributes, the ticket value, the event popularity, artist news associated with the event artist, team performance of a team associated with the event, etc.) may be monitored. Monitoring the ticket context may include monitoring ticket sales, monitoring online or other publications for news about the event, venue, artist, or team, monitoring the user's calendar, monitoring user emails or social media accounts or monitoring other information associated with the ticket, the user, the event, or the venue (as examples).

At step 1104, a swap offer may be provided to the user based on the monitored ticket context. For example, when the monetary value of the price of the purchased ticket rises, the system may detect the rise and provide a swap offer that generates a profit for the user while still allowing the user to attend the event or another event in response to the detected rise. In another example, an important player on a sports team may be placed on an injured list for a game for which the user holds one or more tickets, the system may detect the change to the injury list, identify another event that the user may desire to attend, and provide a swap offer to the user for a ticket from the other identified event. In this way, the monitored ticket context may be used to trigger one or more swap offers to various users. The system may quantify the difference between one or more different attributes of a ticket and calculate a corresponding debit or credit to a user account associated with an exchange of the ticket.

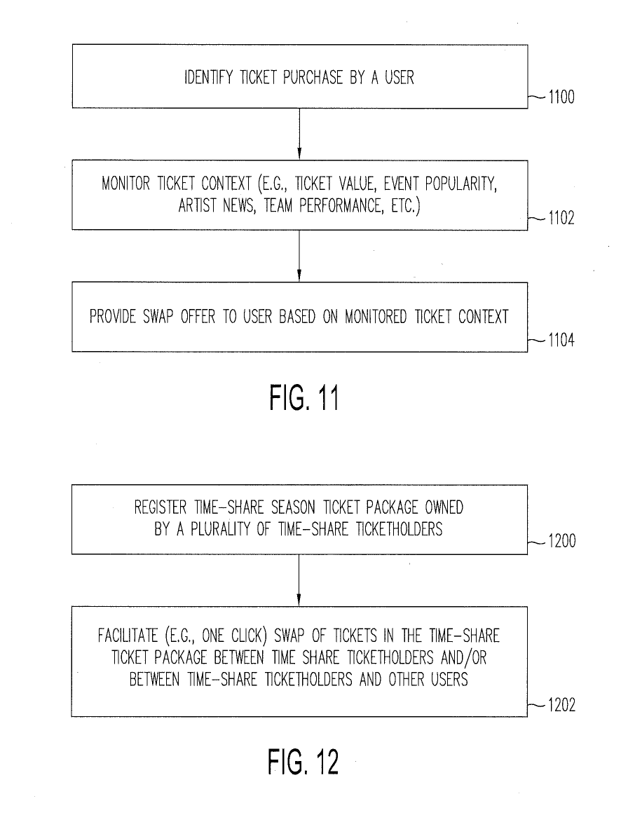

In some circumstances, a group of people may cooperate to purchase a package of tickets such as a season ticket package. The group of people may agree to share the tickets in the manner of a time share so that each member of the group has priority access to associated portions of the time-share season ticket package. However, as is often the case with time share real estate property, the member of the group with access to a particular ticket for a particular event in the season may not be able to attend that event. A system of the type shown in, for example, FIGS. 1 and/or 3 may provide a plurality of time-share ticketholders with the ability to exchange tickets in the time-share season ticket package among the time-share ticketholders or with other users of the system that are not in the group. Illustrative steps that may be performed in connection with exchanging time-share season tickets are shown in FIG. 12.

At step 1200, the system may register a time-share season ticket package owned by a plurality of time-share ticketholders. The time-share season ticket package may be registered by the system in response to one or more of the plurality of time-share ticketholders completing a registration process with the system. The system may store information associated with the time-share season ticket package and the time-share ticketholders.

At step 1202, the system may facilitate the exchange (e.g., a one click ticket swap) of tickets in the time-share season ticket package between the time share ticketholders and/or between the time-share ticketholders and other users. For example, the system may receive information indicating that one of the plurality of time-share ticketholders wishes to exchange tickets for one event for tickets for another event in the season ticket package. The system may then notify the other members of the plurality of time-share ticketholders that an exchange is desired. The system may receive a swap acceptance offer and transfer electronically the tickets to be swapped along with any additional compensation associated with the exchange. If none of the other time-share ticketholders accepts the exchange, a swap offer may be provided to other ticketholders for other events. In this way, the time-share ticketholders may be provided with the ability to use the value of unused season tickets to obtain access to other events and the event venue owner may be provided with a higher capacity crowd by avoiding unused season tickets.

The system may also facilitate the purchase of a time-share ticket package by a plurality of users (e.g., users that collaborate to purchase the time-share season ticket package or users that do not know each other). In this way, users may be provided with the ability to purchase a portion of a season ticket package that is conventionally only available to single purchasers or groups of acquainted purchasers that have coordinated to purchase the season ticket package in advance. The time-share season ticket package may be purchased from the event venue or the event organizer or may be purchased from a user who has previously purchased the season ticket package.

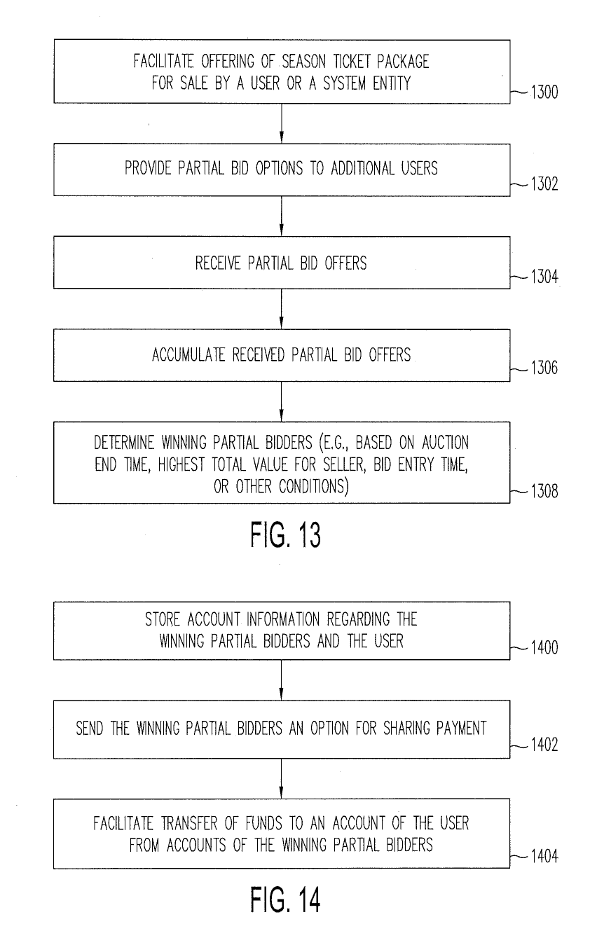

Illustrative steps that may be performed by a system for facilitating the purchase of time-share season ticket package are shown in FIG. 13.

At step 1300, the system may facilitate offering of a season ticket package for sale (e.g., by an entity associated with the system or by a user of the system). Facilitating the offering for sale may include providing a website or application offering the season ticket package along with details of the offered tickets to the public.

At step 1302, the system may provide partial bid options to additional users for bidding on a portion of the season ticket package.

At step 1304, the system may receive one or more partial bid offers (e.g., from other users).

At step 1306, the system may accumulate the partial bid offers offering a payment amount for a portion of the season ticket package.

At step 1308, the system may determine the winning partial bidders (e.g., based on an auction end time, the highest total value for the seller, the bid entry time, or other conditions). For example, the system may receive and accumulate five $300 partial bids for a fifth of the package and eight $200 partial bids for an eighth of the package and, because the total of eight $200 bids ($1600) is higher than the total of five $300 bids ($1500), the eight $200 bidders may win the time-share season ticket package. In another example, if the system receives and stores ten $300 partial bids for a fifth of the package, the first five $300 bidders may be the winners of the package.

The system may also facilitate a group payment for the time-share season ticket package so that the funds corresponding to each partial bid may be transferred directly from the bidder accounts to the seller account without requiring coordination by the bidders or the seller. Illustrative steps that may be performed for facilitating group payment for winning bidders for a time-share season ticket package are shown in FIG. 14.

At step 1400, the system may store account information (e.g., payment account or other financial account information) regarding the winning partial bidders and the user.

At step 1402, the system may send the winning partial bidders an option for sharing payment. For example, the system may send a notification to each of the winning bidders that they have won a portion of the time-share season ticket package and provide the winning bidders with a confirmation virtual button for completing transfer of funds from that bidder's account to the seller's account.

At step 1404, the system may facilitate the transfer of funds to an account of the user from the accounts of the winning partial bidders. In this way, the seller may be provided with a complete payment for the season ticket package without requiring coordination by the winning bidders.

One or more of the processes and steps described in connection with FIGS. 8-14 may be performed in any suitable order, omitted, and/or repeated any suitable number of times for facilitating the purchase, sale, resale, and/or exchange of tickets and/or other goods and/or services.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A system, comprising:
a hardware memory configured to store account information associated with a user; and
a processor coupled to the hardware memory, wherein the processor is configured to:
identify a first item of the user, the first item having a first value of a first attribute;
identify a second item to the user, the second item having a second value of a second attribute; and
facilitate an exchange for the user of the first item for the second item.

2. The system defined in claim 1, wherein the processor is further configured to:
when the first attribute is the same as the second attribute, then determine a difference in the first and second values and calculate a debit or a credit to be provided to an account of the user based on the difference in the first and second values; and
when the first attribute is different from the second attribute, then determine a difference in the first and second attributes and calculate a debit or a credit to be provided to an account of the user based on the difference in the first and second attributes.

3. The system defined in claim 2, wherein the first item is a first event ticket and wherein the first attribute is a price of the event ticket.

4. The system defined in claim 3, wherein:
the second item is a second event ticket and the second attribute is a price of the second event ticket;
the first value is greater than the second value; and
the processor is further configured to:
calculate a difference in the values of the first and second attributes;
offer the exchange of the second item for the first item to the user, the offer identifying the difference in the values;
receive a request to initiate the exchange;
facilitate the exchange of the second item for the first item to the user; and
process a credit to the user based on the difference in the values.

5. The system defined in claim 3, wherein the second item is a second event ticket and wherein the second attribute is a seat of the second event ticket.

6. The system defined in claim 3, wherein the second item is a second event ticket and wherein the second attribute is a date of the second event ticket.

7. The system defined in claim 3, wherein the processor is further configured to:
monitor a ticket context of the first event ticket; and
trigger a swap offer based on the ticket context.

8. The system defined in claim 7, wherein the ticket context includes at least one of a ticket value, an event popularity, a user calendar, or an artist status.

9. The system defined in claim 3, wherein the second item is a second event ticket and wherein the first event ticket and the second event ticket are tickets for a common event.

10. The system defined in claim 3, wherein the second item is a second event ticket, wherein the first event ticket is a ticket for a first event and wherein the second event ticket is a ticket for a second event that is different from the first event.

11. The system defined in claim 1, wherein the first and second items are both tickets in a time-share season ticket package.

12. The system defined in claim 1, wherein the second item is an item of a second user and wherein the processor is further configured to provide the first item to the second user.

13. A method, comprising:
identifying, electronically by one or more hardware processors, a first item of a user, the first item having a first value of a first attribute;
identifying, electronically by the one or more hardware processors, a second item to the user, the second item having a second value of a second attribute;
facilitating, electronically by the one or more hardware processors, an exchange for the user of the first item for the second item.

14. The method defined in claim 13, wherein the first item comprises a first event ticket and wherein the second item comprises a second event ticket of an additional user, the facilitating comprising providing the second event ticket to the user.

15. The method defined in claim 14, further comprising transferring funds from an account of the additional user to an account of the user.

16. The method defined in claim 13, further comprising:
registering a time-share season ticket package owned by a plurality of time-share ticketholders, wherein the first item is a first ticket in the time-share season ticket package, wherein the second item is second ticket in the time-share season ticket package, and wherein the user is one of the plurality of time-share ticketholders.

17. The method defined in claim 16, further comprising:
providing partial bid options to a plurality of additional users for a purchase of the time-share season ticket package from a seller;
receiving a plurality of partial bid offers from at least some of the plurality of additional users; and
determining winning partial bidders for the time-share season ticket package.

18. The method defined in claim 17, wherein the determining comprises determining a combination of the plurality of partial bid offers that results in a highest total value for the seller.

19. A non-transitory machine-readable medium having a plurality of machine-readable instructions which, when executed by one or more processors of a server, are adapted to cause the server to perform a method comprising:
identifying a first item of a user, the first item having a first value of a first attribute;
identifying a second item to the user, the second item having a second value of a second attribute;
facilitating an exchange for the user of the first item for the second item.

20. The non-transitory machine-readable medium defined in claim 19, wherein the method further comprises receiving a swap interest indication from another user that indicates a desire of the other user to exchange the second item.
